(19) United States
(12) Patent Application Publication
(10) Pub. No.: US 2012/0134491 A1
(43) Pub. Date: May 31, 2012

(54) Cloud Storage Data Encryption Method, Apparatus and System

(75) Inventor: Hui LIU, Beijing (CN)

(73) Assignee: Beijing Z & W Technology Consulting Co., Ltd, Beijing (CN)

(21) Appl. No.: 12/976,956

(22) Filed: Dec. 22, 2010

(30) Foreign Application Priority Data
Nov. 29, 2010 (CN) 201010566286.1

(51) Int. Cl. H04L 9/28

(52) U.S. Cl. 380/28

(57) ABSTRACT

This present application relates to the field of cloud storage security technology, and in particular, relates to a cloud storage data encryption method, apparatus and system. The method comprises: according to the amount of data X expected to be stored within the preset time, the proportion of local storage space R and the security level of data Z, calculating the size H of a random seed that should be generated; according to the amount Y of plaintext data every time, calculating the times u of random seed acquired; according to the times u, acquiring data from the generated random seed with the size of H for several times to generate a plaintext encryption bit identifier data string; by use of the data string, selecting more than one half of the plaintext data for encryption to form a ciphertext. This application also provides a cloud storage data encryption apparatus and system. This invention has reduced the amount of encrypted data to be stored without sacrifice in the degree of data security protection, thus greatly improves the cloud storage data encryption and decryption performance.

### BACKGROUND OF THE INVENTION

1. Field of Invention

This invention relates to the field of cloud storage data security technology, and especially relates to a cloud storage data encryption method, apparatus and system.

2. Description of the Related Art

Data has been proven to be an important asset of enterprises, and the rapid growth of data makes enterprises facing unprecedented challenge. Meanwhile, the rapidly changing world's economic situation and cost pressure from fierce competition enable enterprises to have to consider how to reduce IT costs and address growing storage needs of enterprises.

The existing storage architecture can be classified into two types: one is the proprietary architecture for one party, such as DAS (Direct Attached Storage), SAN (Storage Area Network, SAN) and NAS (Network Access Server). Such storage systems are exclusively used by one party, and can provide users with good control, better reliability and performance, but poor scalability, so they do not apply to large-scale deployment; in this mode, it is difficult for users to flexibly use storage budget (one-time investment needed to buy storage equipment); with the increase in storage capacity, cost control will also face challenge.

The other is multi-party sharing architecture, that is, cloud storage architecture; according to different areas of its services, it is classified into private cloud and public cloud. Cloud storage architecture based on network technologies (internet and intranet) provides users with on-demand purchasing and leasing of storage space and on-demand configuration service, for which a third party (or third-party department in enterprises) usually provides storage apparatus and special maintenance personnel. Through the storage service, enterprises (or departments within the enterprises) can significantly reduce the demand for their internal memory and the corresponding administrative costs, to balance the sharp rise in storage demand and business cost pressure. The users of the storage can be individuals, enterprises or even departments within the enterprises or branch offices.

However, for the cloud storage in either mode of operation (private cloud and public cloud), the data owners inevitably concern about its data security and privacy. Especially for the public cloud storage users, if their critical business data are disclosed, the resulting losses are incalculable.

By the traditional methods, all the files or part of the files (for details, please refer to China Patent Application No. CN 200910143245.9 A, “Method to Enable the Cloud Storage Parallel System.”) are encrypted one time or multiple times, and then stored into the specified cloud storage data center, but because the data encryption and decryption need to consume a lot of system resources and time, data access performance of cloud storage service is reduced, users can only apply some data not sensitive to access time to the cloud storage service, and data backup and archiving are usually completed in the non-peak business time, in order to avoid an impact on running critical business applications.

To address the conflict, this invention proposes to apply selective data encryption method into cloud storage data protection, reducing the amount of data to be encrypted (decrypted) but obtaining same data protection degree as the original amount of data to be encrypted, and thus increasing the data access performance of cloud storage service. Compared with the traditional encryption method, the performance of data encryption and decryption is improved without sacrifice in the strength of data protection.

Although the selective data encryption method can improve the performance of data encryption and decryption without sacrificing the strength of data protection with comparison with the traditional methods, users need to sacrifice some local storage space to save the information necessary to restore the data (such as random seed, and reₖ to regenerate a plaintext encryption bit identifier random string), and the occupation of such extra storage space will make their applications face a challenge in the field of cloud storage, because the original intention of users selecting the cloud storage service is to save local storage space.

In order to solve this problem above, the size of the random seed is calculated in this invention, through the amount of data expected to be stored, which are input by users within a certain period of time, and the relative proportion of the physical space planned to be sacrificed and other information, and further by the amount of encryption data submitted every time by users, the data acquisition times required to generate the plaintext encryption bit identifier random string corresponding to the plaintext is calculated and output, thus improving the implementation results of the selective data encryption method used in the field of cloud storage service.

### SUMMARY OF THE INVENTION

The purpose of this invention is to provide a cloud storage data encryption method, apparatus and system, and to address the problem that a lot of system resources and time are consumed when the data to be stored are encrypted or are encrypted for several times through the existing cloud storage data encryption method, and are stored into the specified cloud storage data center, so that the access performance of cloud storage data falls.

This invention provides a cloud storage data encryption method, and the method comprises:

according to the amount of data X expected to be stored into the cloud storage data center within a certain period of time, the proportion of local storage space to occupy R and the level of data security Z, calculating the size H of a random seed that should be generated;

according to the amount Y of plaintext data to be encrypted every time, calculating the data acquisition times u from the random seed;

generating and storing the random seed with the size of H according the preset method;

acquiring data for several times from the random seed, and cascading the data acquired each time into a random string no shorter than the length of a plaintext;

according to the random string, generating a plaintext encryption bit identifier random string;

according to the plaintext encryption bit identifier random string, selecting more than one half of plaintext data for encryption; and

according to their positions in the plaintext, arranging the encrypted data and unencrypted data to form a ciphertext.

This invention provides a cloud storage data encryption apparatus, and the apparatus comprises:

a random seed size and acquisition times calculation module, used for calculating the size H of a random seed that should be generated according to the amount of data X expected to be stored into the cloud storage data center within a certain period of time, the proportion of local storage space R and the level of data security Z, and calculating the data acquisition times u according to the amount Y of plaintext data to be encrypted every time;

a true random number generation module, used for generating random numbers, and for generating the random seed with the corresponding size according to the size of the random seed and the size H of the random seed calculated by the random seed size and acquisition times calculation module;

an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;

a plaintext selective data encryption module for randomly selecting more than one half of the plaintext data for encryption according to the plaintext encryption bit identifier random string generated by the encryption bit identifier random string generation module;

a ciphertext formation module for arranging the data encrypted by the plaintext selective data encryption module and the unencrypted data according to their positions in the plaintext to form a ciphertext.

This invention also provides a cloud storage data encryption system, and the system includes a cloud storage data encryption apparatus and a cloud storage data center. The cloud storage data encryption apparatus comprises:

a random seed size and acquisition times calculation module, used for calculating the size H of a random seed that should be generated according to the amount of data X expected to be stored into the cloud storage data center within a certain period of time, the proportion of local storage space R and the level of data security Z, and calculating the data acquisition times u according to the amount Y of plaintext data to be encrypted every time;

a true random number generation module, used for generating random numbers, and for generating the random seed with the corresponding size according to the size of the random seed and the size H of the random seed calculated by the random seed size and acquisition times calculation module;

an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;

a plaintext selective data encryption module for randomly selecting more than one half of the plaintext data for encryption according to the plaintext encryption bit identifier random string generated by the encryption bit identifier random string generation module;

a ciphertext formation module for arranging the data encrypted by the plaintext selective data encryption module and the unencrypted data according to their positions in the plaintext to form a ciphertext.

In this invention, according to the amount of data X expected to be stored into the cloud storage data center within the preset time, the proportion of local storage space R and the level of data security Z, calculating the size H of a random seed that should be generated; according to the amount of plaintext data Y to be encrypted every time, calculating the data acquisition times u from the random seed and to generate the random seed with the size of H; according to the times u, acquiring data for several times to generate a plaintext encryption bit identifier random string, selecting more than one half of the plaintext data for encryption, and arranging encrypted and unencrypted data according to their positions in the plaintext to form a ciphertext, and saving in the cloud storage data center, thus, without sacrificing the strength of data security protection, reducing the number of data for encryption before storage, and enhancing the data access performance of cloud storage.

### BRIEF DESCRIPTION OF THE DRAWINGS

FIG. 1 shows a flow chart of the cloud storage data encryption method provided in the embodiment of this invention;

FIG. 2 shows a flow chart of the method for the generation of a plaintext encryption bit identifier data string the same long as the plaintext provided in the embodiment of this invention;

FIG. 3 shows a flow chart of the method for the determination of whether a plaintext encryption bit identifier data string has already been generated provided in the embodiment of this invention;

FIG. 4 shows a structure diagram of the cloud storage data encryption apparatus provided in the embodiment of this invention;

FIG. 5 shows a schematic diagram of the random seed size and acquisition times calculation module provided in the embodiment of this invention;

FIG. 6 shows a structure diagram of the cloud storage data encryption system provided in the embodiment of this invention;

FIG. 7 shows a schematic diagram for the generation method of a plaintext encryption bit identifier random string provided in the embodiment of this invention;

FIG. 8 shows a schematic diagram for the cloud storage data encryption and decryption method provided in the embodiment of this invention.

### DETAILED DESCRIPTION OF THE PRESENTLY PREFERRED EMBODIMENTS

The following preferred embodiments are provided for further illustrating, but not for limiting, the present invention.

In this invention, according to the amount of data X expected to be stored into the cloud storage data center within the preset time, the proportion of local storage space R and the level of data security Z, calculating the size H of a random seed that should be generated; according to the amount of plaintext data Y to be encrypted every time, calculating the data acquisition times u from random seed; generating the random seed with the size of H, according to the times u, acquiring data for several times to generate a plaintext encryption bit identifier random string, selecting more than one half of the plaintext data for encryption, and arranging encrypted and unencrypted data according to their positions in the plaintext to form a ciphertext, and storing it in the cloud storage data center.

The embodiment of this invention is implemented by a cloud storage data encryption method comprising:

according to the amount of data X expected to be stored into the cloud storage data center within a certain period of time, the proportion of local storage space to occupy R and the level of data security Z, calculating the size H of a random seed that should be generated;

according to the amount Y of plaintext data to be encrypted every time, calculating the data acquisition times u from the random seed;

generating and storing the random seed with the size of H according the preset method;

acquiring data for several times from the random seed, and cascading the data acquired each time into a random string no shorter than the length of a plaintext;

according to the random string, generating a plaintext encryption bit identifier random string;

according to the plaintext encryption bit identifier random string, selecting more than one half of plaintext data for encryption; and

according to their positions in the plaintext, arranging the encrypted data and unencrypted data to form a ciphertext.

The purpose of this invention is to provide a cloud storage data encryption apparatus, and the apparatus comprises:

a random seed size and acquisition times calculation module, used for calculating the size H of a random seed that should be generated according to the amount of data X expected to be stored into the cloud storage data center within a certain period of time, the proportion of local storage space R and the level of data security Z, and calculating the data acquisition times u according to the amount Y of plaintext data to be encrypted every time;

a true random number generation module, used for generating random numbers, and for generating the random seed with the corresponding size according to the size of the random seed and the size H of the random seed calculated by the random seed size and acquisition times calculation module;

an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;

a plaintext selective data encryption module for randomly selecting more than one half of the plaintext data for encryption according to the plaintext encryption bit identifier random string generated by the encryption bit identifier random string generation module;

a ciphertext formation module for arranging the data encrypted by the plaintext selective data encryption module and the unencrypted data according to their positions in the plaintext to form a ciphertext.

Another purpose of the embodiment of this invention is also to provide a cloud storage system, and the system comprises a cloud data storage encryption apparatus and a cloud storage data center. The cloud storage data encryption apparatus comprises:

a random seed size and acquisition times calculation module, used for calculating the size H of a random seed that should be generated according to the amount of data X expected to be stored into the cloud storage data center within a certain period of time, the proportion of local storage space R and the level of data security Z, and calculating the data acquisition times u according to the amount Y of plaintext data to be encrypted every time;

a true random number generation module, used for generating random numbers, and for generating the random seed with the corresponding size according to the size of the random seed and the size H of the random seed calculated by the random seed size and acquisition times calculation module;

an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;

a plaintext selective data encryption module for randomly selecting more than one half of the plaintext data for encryption according to the plaintext encryption bit identifier random string generated by the encryption: bit identifier random string generation module;

a ciphertext formation module for arranging the data encrypted by the plaintext selective data encryption module and the unencrypted data according to their positions in the plaintext to form a ciphertext.

In combination with the following drawings and the embodiment of this invention, this invention is further described below.

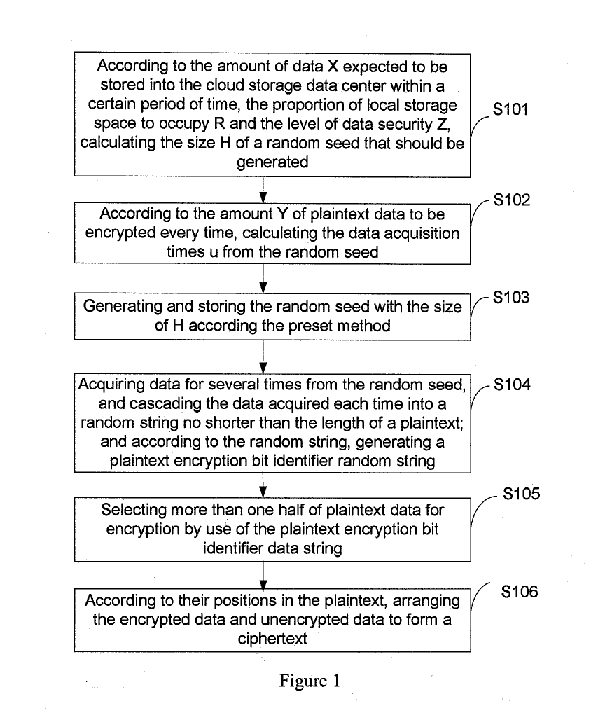

As shown in FIG. 1, the embodiment of this invention provides a cloud storage data encryption method, including the following steps:

Step S101: according to the amount of data X expected to be stored into the cloud storage data center within a certain period of time, the proportion of local storage space to occupy R and the level of data security Z, calculating the size H of a random seed that should be generated;

Step S102: according to the amount Y of plaintext data to be encrypted every time, calculating the data acquisition times u from the random seed;

Of which, the proportion of local storage space R means the ratio of the local storage space occupied by the necessary information needed to be saved and used to decrypt and restore the encrypted data, such as random seeds and the corresponding information of a plaintext encryption bit identifier random string;

In the embodiment of this invention,

$$H = \frac{X}{R} - \frac{8 X}{Z} = X ( \frac{1}{R} - \frac{8}{Z} )$$

where Z=Y/u, and Z>8R;

It can be seen after X, R and Z are given by users, they can get a certain H;

Similarly, according to the amount of data encrypted by users every time, the data acquisition times u from the random seed can be calculated based on a certain Z by using the above formula;

For example, if it is expected for a user to store 100G data into the specified cloud storage service data center in the next 3 years, the security level of data protection required for the R=1000 that the user can accept is Z=10K bytes; further, according to the above formula, H=20 M bytes can be calculated.

If the amount of plaintext data encrypted one time is 1 MB, the corresponding times of data acquisition is u=100.

Step S103: generating and storing the random seed with the size of H according the preset method;

The generation method for true random numbers has been very mature, and in the specific implementation, the method for the generation of random numbers given in Page 301 of Applied Cryptography issued by Mechanical Industry Press on Mar. 1, 2003 can be used, such as the required true random number generated by use of random noise, computer clock, CPU load or the number of network packets and other methods;

Step 104: acquiring data for several times from the random seed, and cascading the data acquired each time into a random string no shorter than the length of a plaintext; and according to the random string, generating a plaintext encryption bit identifier random string;

In the embodiment of this invention, the starting position where data are randomly acquired for several times from the random seed every time, and the acquisition length are random;

To further enhance the randomness of data acquisition, after the data acquired every time are cascaded into a data string of 0, 1 values no less than the length of the plaintext, the embodiment of this invention can also comprise the following steps:

acquiring data for several times from the random string to generate a new random string equal to the length of the plaintext;

Preferably, in the embodiment of this invention, when data are acquired from the random string for several times, the starting position where data are acquired every time is random.

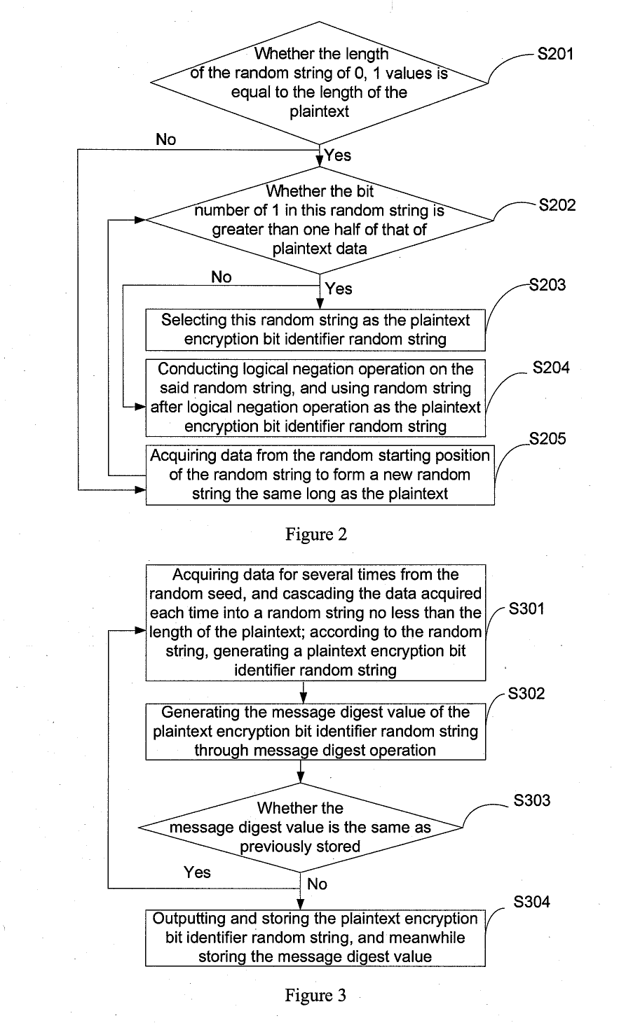

As shown in FIG. 2, in the embodiment of this invention, the specific steps to generate a plaintext encryption bit identifier data string by use of the generated random string are shown as follows:

Step S201: determining whether the random string is equal to length of the plaintext; if so, to perform Step S202, and if not, to perform Step S205;

Step S202: determining whether the number of 1 in the random string is greater than one half of plaintext data bits; if so, to perform Step S203, and if not, to perform Step S204;

Step S203: selecting the random string as a plaintext encryption bit identifier random string;

Step S204: conducting logical negation operation on the random string, and using the negated random string as the plaintext encryption bit identifier random string;

Step S205: acquiring data from the random starting position of the random string to form a new random string equal to the length of the plaintext, and then to perform Step S202;

When data are acquired from the random starting position of the random string, if the data are acquired to the tail of the random string but enough data have not yet been acquired, going back to the head to continue acquiring until the data the same long as the plaintext have been acquired, and generating a new random string;

Step 105: selecting more than one half of plaintext data for encryption by use of the plaintext encryption bit identifier data string:

As shown in FIG. 8, in the embodiment of this invention, the specific steps selecting more than one half of plaintext data for encryption to form a ciphertext by use of the plaintext encryption bit identifier data string comprise:

starting from the first bit of data, arranging the plaintext encryption bit identifier random string and plaintext data correspondingly bit by bit in parallel; and

selecting the position of plaintext data corresponding to 1 in the plaintext encryption bit identifier random string as the encrypted data.

In the embodiment of this invention, the encryption function used at the time of encryption corresponds to a unique encryption key;

Step 106: according to their positions in the plaintext, arranging the encrypted data and unencrypted data to form a ciphertext.

As shown in FIG. 3, in the embodiment of this invention, after the step in which a plaintext encryption bit identifier random string is generated according to the random string, also determining whether the plaintext encryption bit identifier random string has already been generated, if yes, regenerating a new plaintext encryption bit identifier random string; otherwise outputting and storing the plaintext encryption bit identifier random string. The specific implementation steps are as follows:

Step S301: acquiring data from a random seed for several times, cascading the data acquired every time into a random string no less than the length of the plaintext, and according to the random string, generating a plaintext encryption bit identifier random string;

Step S302: generating the message digest value of the plaintext encryption bit identifier random string through message digest operation;

The message digest of the plaintext encryption bit identifier random string can be calculated by use of MD5 or SHA1 algorithm;

Step S303: determining whether the message digest value is consistent with the message digest values of the stored plaintext encryption bit identifier random strings; if so, to perform Step S301, otherwise to perform Step S304;

Step S304: outputting and storing the plaintext encryption bit identifier random string, and meanwhile storing the message digest value.

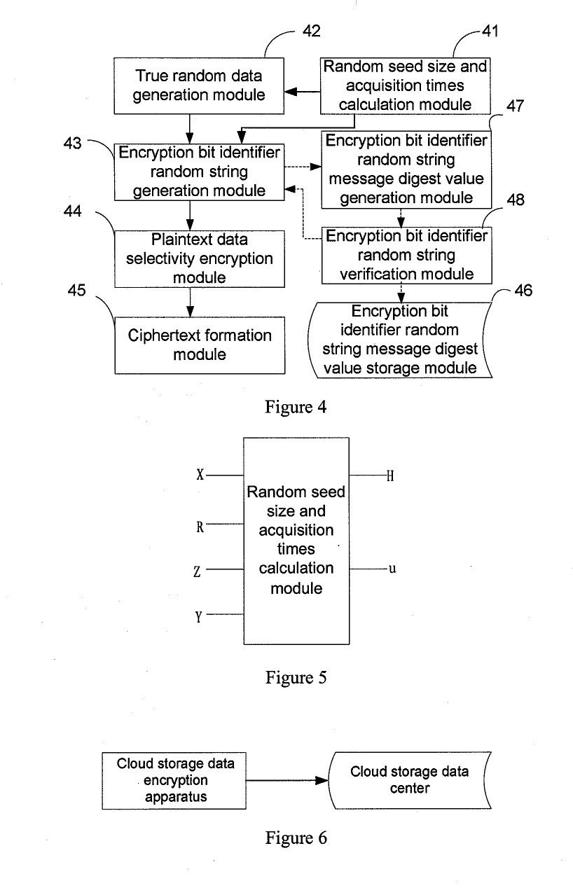

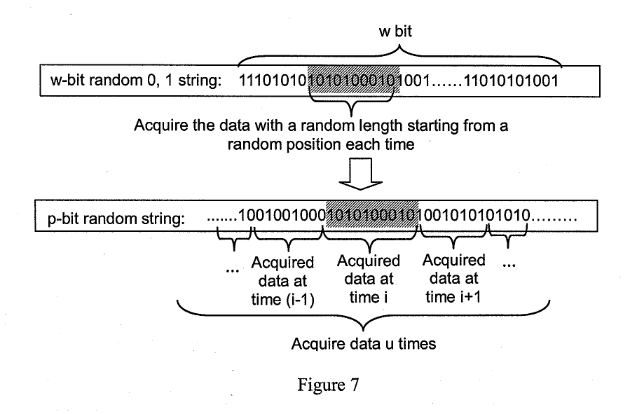

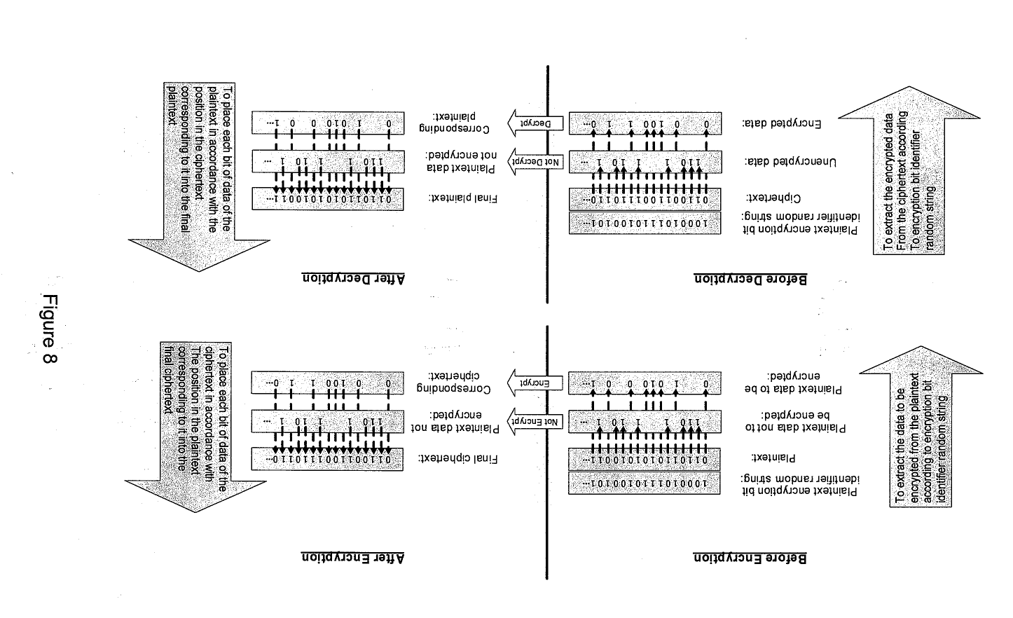

As shown in FIG. 4, the embodiment of this invention provides the structure of a cloud storage data encryption apparatus, and in order to facilitate the description, only the relevant part of this invention is shown.

The apparatus includes a random seed size and acquisition times calculation module 41, true random data generation module 42, encryption bit identifier random string generation module 43, plaintext data selectivity encryption module 44 and ciphertext formation module 45;

Random seed size and acquisition times calculation module 41 functions to calculate the size H of a random seed that should be generated according to the amount of data X expected to be stored into the cloud storage data center within the determined period of time, the proportion of local storage space R and the level of data security Z, and to calculate the data acquisition times u from the random seed according to the amount Y of plaintext data to be encrypted every time.

True random data generation module 42 functions for generating true random numbers, and generating the random seed with the corresponding size H calculated by the random seed size and acquisition times calculation module 41; encryption bit identifier random string generation module 43 functions for acquiring data for several times from the random seed generated by true random data generation module 42 according to the data acquisition times u calculated by the random seed size and acquisition times calculation module 41, and cascading the data acquired every time into a random string of 0, 1 values no less than the length of the plaintext and generating a plaintext encryption bit identifier random string according to the random string;

Plaintext data selectivity encryption module 44, according to the plaintext encryption bit identifier random string generated by the encryption bit identifier random string generation module 43, functions for selecting more than one half of plaintext data for encryption; ciphertext formation module 45 is used for arranging the data encrypted by the plaintext selective data encryption module and the unencrypted data according to their positions in the plaintext to form a ciphertext.

As shown in FIG. 4, the apparatus provided in the embodiment of this invention comprises:

Encryption bit identifier random string message digest value storage module 46, encryption bit identifier random string message digest value generation module 47 and encryption bit identifier random string verification module 48;

Encryption bit identifier random string message digest, value storage module 46 functions for storing the encryption bit identifier random string message digest values;

Encryption bit identifier random string methage digest value generation module 47 functions, through message digest operation, for generating the message digest value of the plaintext encryption bit identifier random string generated by the encryption bit identifier random string generation module 43;

Encryption bit identifier random string verification module 48 functions for comparing the message digest value of the plaintext encryption bit identifier random string generated by the encryption bit identifier random string message digest value generation module 47 and the message digest values in the encryption bit identifier random string message digest value storage module 46, and to output the information whether same or not, to the encryption bit identifier random string generation module.

As shown in FIG. 5, the embodiment of this invention provides a schematic diagram about the size of random seed generated by the random seed size and acquisition times calculation module and about the data acquisition times from the random seed; in this diagram, X is the amount of data expected to be stored in the cloud storage data center within a certain period of time, R is the proportion of local storage space for saving information required to restore and decrypt the data, Z is the level of data security, Y is the amount of plaintext data to be encrypted every time, H is the size of the random seed that should be generated, and u is the data acquisition times from the random seed.

After users set X, R, Z in the module according to their requirements, the module according to the corresponding formula can calculate the size H of the random seed that should be generated, and in accordance with the amount Y of plaintext data encrypted every time, calculate the data acquisition times u from the random seed.

As shown in FIG. 6, the embodiment of this invention provides a cloud storage data encryption system, and the system comprises a cloud storage data encryption apparatus and a cloud storage data center.

Of which, the cloud storage data encryption apparatus includes the random seed size and acquisition times calculation module 41, true random data generation module 42, encryption bit identifier random string generation module 43, plaintext data selectivity encryption module 44 as well as ciphertext formation module 45, as shown in FIG. 4 below.

Random seed size and acquisition times calculation module 41 functions for calculating the size H of a random seed that should be generated according to the amount of data X expected to be stored into the cloud storage data center within a certain period of time, the proportion of local storage space R and the level of data security Z, and for calculating the data acquisition times u from the random data according to the amount Y of plaintext data to be encrypted each time;

True random data generation module 42 functions for generating true random numbers, and generating the random seed with the corresponding size H calculated by the random seed size and acquisition times calculation module; encryption bit identifier random string generation module 43 functions for acquiring data for several times from the random seeds generated by true random data generation module 42 according to the size of random seed and the data acquisition times u calculated by the random seed size and acquisition times calculation module 41, and cascading the data acquired every time into a random string of 0, 1 values no less than the length of the plaintext and generating a plaintext encryption bit identifier random string according to the random string;

Plaintext data selectivity encryption module 44, according to the plaintext encryption bit identifier random string generated by the encryption bit identifier random string generation module 43, functions for selecting more than one half of plaintext data for encryption; ciphertext formation module 45 is used for arranging the data encrypted by the plaintext selective data encryption module and the unencrypted data according to their positions in the plaintext to form a ciphertext.

Here, two implementation methods for selecting more than one half of plaintext data for encryption are provided, but the scope of protection of this invention is not limited to the two implementations.

### Method 1: Fixed-Bit Constant-Length Plaintext Encryption Method

Assuming there are several plaintexts to be encrypted, select the plaintext k, and the plaintext has m bits, and n bits need to be selected for encryption, of which m, n and k are natural number and

$$n \geq [ \frac{m}{2} ] + 1 , [ \frac{m}{2} ]$$

is the rounding operation on

$$\frac{m}{2} .$$

The main steps for the method of selecting randomly data from the plaintext k for encryption are as follows:

1. Generating and storing a string of random number 0, 1 of the predetermined length w bits as a random seed, of which w is natural number, and w>m;

2. Acquiring data randomly from the random seed for the predetermined times u (u is natural number), and the starting position of each time acquired data and the length of acquired data (can be greater than or equal to 0) are random; if the data are acquired to the tail of the random seed, return to the head to continue data acquisition;

Before each data acquisition, two random numbers are first generated, and they are modulo operated respectively to obtain a random starting cursor position and the length of the data required to be acquired;

In details, prior to the data acquisition, generating two random numbers R1, R2 at first, and then generating two random values T1, T2 respectively less than w and p−q (in which, q is a natural number less than or equal to q, w is the length of the random seed, p is the length of the plaintext encryption bit identifier random string required to be generated, q is the length of the data already generated, and p−q is the number of bits of the remaining data not acquired in the random string), then

T1=R1 mod w

T2=R2 mod(p−q)

Where, mod is modulo operation.

3. Cascading the data acquired each time into a p-bit random string of 0, 1 values (p is natural number, and p=m in this method);

4. Counting the number n of 1 in the random string, and in case of

$$n \geq [ \frac{m}{2} ] + 1 ,$$

selecting the random string as the plaintext encryption bit identifier random string.

In case of

$$n < [ \frac{m}{2} ] + 1 ,$$

conducting logical negation operation on the whole random string, and then

$$n \geq [ \frac{m}{2} ] + 1 ,$$

using random string after logical negation operation as the plaintext encryption bit identifier random string;

5. Outputting m-bit plaintext encryption bit identifier random string, starting from the first bit of data, arranging this plaintext encryption bit identifier random string and plaintext data correspondingly bit by bit in parallel, and encrypting the plaintext data corresponding to 1 in the plaintext encryption bit identifier random string.

As shown in FIG. 4, the embodiment of this invention provides the schematic diagram for the generation method of plaintext encryption bit identifier random string.

In this diagram, if identifying the m-bit plaintext encryption bit identifier random string corresponding to the plaintext k as reₖ, then reₖ is equal to the sequence combination or logical negation result (if

$$n < [ \frac{m}{2} ] + 1 \text{)}$$

of the data randomly acquired for u times from the random seed of the specified length; identifying the data acquired from the random seed at the time i as (Curₛ, Curₑ)ᵢ, where, i is a natural number, and i≦u, and Curₛ is the starting cursor position for the data acquired at the time i from the random seed; accordingly, Curₑ is the ending cursor position for the data acquired at the time i. Curₛ and Curₑ are offset identifiers from the first bit of the random steed; clearly both Curₛ and Curₑ are integer numbers greater than or equal to 0, and less than or equal to m, and Curₑ is greater than or equal to Curₛ. When Curₑ is equal to Curₛ, the bits of data acquired at the determined time is 0. Thus, the data acquired at the time i is bits of data between Curₛ and Curₑ in the random seed. Further, the plaintext encryption bit identifier random string reₖ can be expressed as:

reₖ=[(Curₛ,Curₑ)₁,(Curₛ,Curₑ)₂, . . . (Curₛ,Curₑ)ᵢ . . . (Curₛ,Curₑ)ᵤ]ₖ

$$( When n \geq [ \frac{m}{2} ] + 1 )$$

Or

reₖ=˜[(Curₛ,Curₑ)₁,(Curₛ,Curₑ)₂, . . . (Curₛ,Curₑ)ᵢ, . . . (Curₛ,Curₑ)ᵤ]ₖ

$$( When n < [ \frac{m}{2} ] + 1 )$$

In the following, the true randomness or non-reproducibility of the plaintext encryption bit identifier random string is analyzed:

It is critical for the entire system not to be easily cracked by cryptanalysts to ensure the true randomness and non-reuse of the plaintext encryption bit identifier random string.

It should be noted that as long as the character used as a plaintext encryption bit identifier random string is limited, the key may be reproduced, and its randomness is reflected in very small probability of reproducibility and irregular reproducibility.

For example, assuming that the plaintext encryption bit identifier random string has 1024 bits, because only 0 and 1 can form the random string, no matter how they are random, the probability of their reproducibility is still greater than 1/2¹⁰²⁴, or 1/(1.79*10³⁰⁸.)

Further, the probability of repeated plaintext encryption bit identifier random strings in the implementation can be calculated. For the same random seed, because there can be w kinds of data acquisition possibilities every time (random seed is w-bit), in this implementation, after data are acquired for u times, the probability of reproducibility of random string of encrypted bit identifiers of the p-bit plaintext is 1/w^{u}.

If the specified encryption algorithm (function) is used to encrypt 10 M bytes plaintext, the size of the used random seed is 1 Gbit, i.e. w=1,000,000,000, and data are acquired for 1000 times, that is, u=1000, the probability of the repeated plaintext encryption bit identifier random strings produced through the implementation method is 1/10⁹⁰⁰⁰, so the probability of repeatability is low enough, in line with the characteristics of random features.

In actual use, users can continue to improve its randomness by increasing the u and w to reduce the probability of its repetition, or by periodic replacement of the random seed, to ensure a more secure plaintext encryption bit identifier random string.

### Method 2: Variable-Bit Variable-Length Plaintext Encryption Method

Similar to Method 1, the difference is that p in the implementation is of uncertain length, starting to traverse and generate a plaintext encryption bit identifier random string from the random position of p-bit random string. By the uncertainty of the starting traversal position, the security of the entire system is enhanced.

The specific implementation steps are as follows (the data are set similar to the method 1):

1. Generating and storing a random number 0, 1 string of the predetermined length w bits as a random seed, of which w is natural number, and w>m;

2. Acquiring random data from the random seed for the determined times u (u is natural number), and the starting position of data acquired every time and the length of the data acquired (which can be greater than or equal to 0) are random; if the data has been acquired to the tail of the random seed, return to the head to continue data acquisition;

Before each data acquisition, generate two true random numbers at first, and then conduct modulo operations on the two random numbers respectively to obtain the starting cursor position needed for the random data acquisition and the length of the data required for being acquired. The method for the random data acquisition of the random seed is the same as Method 1;

3. Cascading the data acquired every time into a specified p-bit random string (p is natural number, p>m);

4. Acquiring m-bit data from a random starting position in the p-bit random string, and when the data is acquired to the tail of the random string, need to return the head to continue acquiring until enough bits are acquired, and outputting a new random string; it is need to note that, the random starting position needs to be determined by modulo the random number generated.

In details, generating a true random number R3 before data acquisition, and then generating a random value T3 less than p, that is,

T3=R3 mod p

Where, mod is modulo operation.

5. Counting and determining the number n of 1 in the random string, and in case of

$$n \geq [ \frac{m}{2} ] + 1 ,$$

selecting the random string as the plaintext encryption bit identifier random string.

In case of

$$n < [ \frac{m}{2} ] + 1 ,$$

conducting logical negation operation on the whole random string, so that

$$n \geq [ \frac{m}{2} ] + 1 ,$$

using random string after logical negation operation as the plaintext encryption bit identifier random string;

6. Outputting m-bit plaintext encryption bit identifier random string, corresponding them to the plaintext data bit by bit starting from the first data in order, and encrypting the plaintext data corresponding to 1 in the plaintext encryption bit identifier random string.

The true randomness or non-reproducibility of the plaintext encryption bit identifier random string with this method is analyzed in the following.

Compared with the method 1, a step is added into the method 2, that is, m-bit data are acquired from p-bit random string; because there are p kinds of possibilities for data acquisition, the probability of repetition of the plaintext encryption bit identifier random string in the method 2 is p*1/(p*w^{u}).

Further, taking the data set in the method 1 as an example, where p>m, i.e. p>80,000,000 (or 80M-bit), the minimum probability of the repeated plaintext encryption bit identifier random string generated through the method is 1/(8*10⁹⁰⁰⁷), and it shows the probability of repetition is low enough, in line with the characteristic of random features.

In actual use, to continue to improve its randomness by increasing p, u and w (reduce the probability of its repetition), or replacing periodically the random seed to ensure a more secure plaintext encryption bit identifier random string.

In short, through the implementations above, it can be proved that it is feasible to enable selective data encryption in the practical application.

In this invention, at the time of selective data encryption, it is need to record and store the generated random seed, the corresponding information reₖ used for re-generating, from the random seed, the plaintext encryption bit identifier random string corresponding to the plaintext k to encrypt, information about whether to conduct logical negation operation or not when a plaintext encryption bit identifier random string is generated, and the starting traversal cursor position of data acquisition when the p-bit random string is acquired to generate a plaintext encryption bit identifier random string, for decrypting the data.

As shown in FIG. 8, the decryption steps are as follows:

1. Acquiring data from the stored random seed, and regenerating the plaintext encryption bit identifier random string corresponding to the encrypted plaintext, according to the information saved in the process of data encryption, such as the random seed, the corresponding information reₖ used for re-generating, from the random seed, the plaintext encryption bit identifier random string corresponding to the plaintext k to encrypt, information about whether to conduct logical negation operation or not when a plaintext encryption bit identifier random string is generated, and the starting traversal cursor position of data acquisition when the p-bit random string is acquired to generate a plaintext encryption bit identifier random string;

2. Extracting the encrypted data from the ciphertext according to the plaintext encryption bit identifier random string and then decrypting them;

In the embodiment of this invention, the decryption function for decrypting the encrypted plaintext (i.e. ciphertext) is corresponding to the encryption function;

3. Arranging the decrypted data and unencrypted data according to their positions in the ciphertext to form a plaintext.

In the embodiment of this invention, according to the amount of data X expected to be stored into the cloud storage data center within a certain period of time, the proportion of local storage space R and the level of data security Z, calculating the size H of a random seed that should be generated; according to the amount of plaintext data Y to be encrypted every time, calculating the data acquisition times u from the random seed, and generating the random seed with the size of H; according to the times u, acquiring data for several times from the random seed, to generate a plaintext encryption bit identifier random string; selecting more than one half of the plaintext data for encryption, and arrange them with the unencrypted data according to their positions in the plaintext to form a ciphertext, and then storing it in the cloud storage data center, thus, without sacrifice in the degree of data security protection, reducing the amount of data to be encrypted, and enhancing the data backup and achieving performance to cloud storage data center; at the time of decryption, regenerating the plaintext encryption bit identifier random string corresponding to the encrypted plaintext, and using this random string to decrypt the ciphertext, thus reducing the amount of data to be decrypted, and greatly enhancing the data retrieving performance from cloud storage data center.

All above is just the preferred embodiment of this invention, but is not used to limit this invention; any changes, equivalent replacements and improvements and other aspects made within the spirit and principle of this invention should be included in the protective range of this invention.

I claim:

1. A cloud storage data encryption method comprising:
according to the amount of data X expected to be stored into a cloud storage data center within a determined period of time, the proportion of local storage space to occupy R and the level of data security Z, calculating the size H of a random seed that should be generated;
according to the amount Y of plaintext data to be encrypted every time, calculating the data acquisition times u from the random seed;
generating and storing the random seed with the size of H according a preset method;
acquiring data for several times from the random seed, and cascading the data acquired each time into a random string of no shorter than the length of a plaintext;
according to the random string, generating a plaintext encryption bit identifier random string;
according to the plaintext encryption bit identifier random string, selecting more than one half of plaintext data for encryption; and
according to their positions in the plaintext, arranging the encrypted data and unencrypted data to form a ciphertext.

2. The method of claim 1 wherein
$$H = \frac{X}{R} - \frac{8 X}{Z} = X ( \frac{1}{R} - \frac{8}{Z} ) ,$$
where Z=Y/u, and Z>8R.

3. The method of claim 1 wherein the starting position where data is randomly acquired from the random seed every time and the data acquisition length are random.

4. The method of claim 1 wherein the steps of cascading and generating the data acquired every time into a random string of 0, 1 values of no less than the length of the plaintext comprise:
when the length of the random string is greater than the length of the plaintext, data is acquired from the random string for several times to generate a new random string of no less than the length of the plaintext.

5. The method of claim 1 wherein the step of generating a plaintext encryption bit identifier data string by use of the random string comprises:
when the length of the random string is equal to the length of the plaintext, determining whether the number of 1 in the random string is greater than one half of the data bits of the plaintext; if so, selecting the random string as the plaintext encryption bit identifier random string; if not, conducting logical negation operation on the random string, and using the random string after logical negation operation as the plaintext encryption bit identifier random string;
when the length of the random string is greater than the length of the plaintext, acquiring data from the random starting position of the random string to form a new random string of the same length as the plaintext; determining whether the number of 1 in the new random string is greater than one half of the data bits of the plaintext; if so, selecting the new random string as the plaintext encryption bit identifier random string; if not, conducting logical negation operation on the new random string, and using the new random string after logical negation operation as the plaintext encryption bit identifier random string.

6. The method of claim 1 wherein the step of generating a plaintext encryption bit identifier data string by use of the random string comprises:
generating a message digest value of the plaintext encryption bit identifier random string by the message digest operation; and
determining whether the message digest value is the same as the message digest value of the previously stored plaintext encryption bit identifier random string; if so, re-generating the plaintext encryption bit identifier random string; otherwise outputting and storing the plaintext encryption bit identifier random string, and meanwhile storing its message digest value.

7. The method of claim 1 wherein the step of selecting more than one half of the plaintext encryption bit identifier random string for encryption by use of the plaintext encryption bit identifier data string to form a ciphertext comprises:
starting from the first bit of data, arranging the plaintext encryption bit identifier random string and plaintext data correspondingly bit by bit in parallel; and
selecting the position of plaintext data corresponding to 1 in the plaintext encryption bit identifier random string as the encrypted data.

8. A cloud storage data encryption apparatus comprising:
a random seed size and acquisition times calculation module for calculating the size H of a random seed that should be generated according to the amount of data X expected to be stored into the cloud storage data center within a determined period of time, the proportion of local storage space R and the level of data security Z, and calculating the data acquisition times u according to the amount Y of plaintext data to be encrypted every time;
a true random number generation module for generating random numbers, and for generating the random seed with the corresponding size according to the size of the random seed and the size H of the random seed calculated by the random seed size and acquisition times calculation module;
an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;
a plaintext selective data encryption module for randomly selecting more than one half of the plaintext data for encryption according to the plaintext encryption bit identifier random string generated by the encryption bit identifier random string generation module; and
a ciphertext formation module for arranging the data encrypted by the plaintext selective data encryption module and the unencrypted data according to their positions in the plaintext to form a ciphertext.

9. The apparatus of claim 8 wherein the apparatus also comprises:
an encryption bit identifier random string message digest value storage module for storing the message digest value of encryption bit identifier random string;
an encryption bit identifier random string message digest value generation module for generating by the message digest value operation a message digest value of the plaintext encryption bit identifier random string generated by the encryption bit identifier random string generation module, and returning the message digest value to the encryption bit identifier random string message digest value storage module; and
an encryption bit identifier random string verification module for comparing message digest value of the plaintext encryption bit identifier random string generated by the encryption bit identifier random string generation module and the message digest value in the encryption bit identifier random string message digest value storage module, and outputting the comparison result to the encryption bit identifier random string generation module.

10. A cloud storage data encryption system comprising a cloud storage data encryption apparatus and a cloud storage data center; wherein the cloud storage data encryption apparatus comprises:
a random seed size and acquisition times calculation module, used for calculating the size H of a random seed that should be generated according to the amount of data X expected to be stored into the cloud storage data center within a certain period of time, the proportion of local storage space R and the level of data security Z, and calculating the data acquisition times u according to the amount Y of plaintext data to be encrypted every time;
a true random number generation module, used for generating random numbers, and for generating the random seed with the corresponding size according to the size of the random seed and the size H of the random seed calculated by the random seed size and acquisition times calculation module;
an encryption bit identifier random string generation module for acquiring data for several times from random seed generated by the true random number generation module, cascading the data acquired each time into a random string no shorter than the length of a plaintext, and according to the random string, generating a plaintext encryption bit identifier random string;
a plaintext selective data encryption module for randomly selecting more than one half of the plaintext data for encryption according to the plaintext encryption bit identifier random string generated by the encryption bit identifier random string generation module; and
a ciphertext formation module for arranging the data encrypted by the plaintext selective data encryption module and the unencrypted data according to their positions in the plaintext to form a ciphertext.
